(19) United States
(12) Patent Application Publication
(10) Pub. No.: US 2008/0107350 A1
(43) Pub. Date: May 8, 2008

(54) Method for Production of an Image Recording and/or Reproduction Device and Device Obtained By Said Method

(76) Inventors: Frederic Guichard, Paris (FR); Bruno Liege, Boulogne (FR); Jerome Meniere, Paris (FR)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/814,323

(22) PCT Filed: Jan. 18, 2006
(86) PCT No.: PCT/FR06/50022

§ 371 Date: Sep. 17, 2007

(30) Foreign Application Priority Data
Jan. 19, 2005 (FR) 0550163

(51) Int. Cl. G06K 9/40

(52) U.S. Cl. 382/255

(57) ABSTRACT

A method for production of an image recording and/or reproduction device, including an optical image recording and/or reproduction system, an image sensor and/or generator and/or a synchronization system, the image being processed for improvement by a digital image processor. According to the method, parameters of the optical system and/or the sensor and/or the image generator and/or the synchronization system are determined or selected using the capacity of the digital image processor. The production costs are thus minimized and/or the performance of the image recording and/or reproduction device is optimized.

The invention relates to a method for production of an image recording and/or reproduction device comprising an optical image recording and/or reproduction system, an image sensor and/or generator and/or a synchronisation system, said image being processed for improvement by digital image processing means.

The invention is particularly aimed at optimising the aperture of the optical system of an image recording and/or reproduction device.

The invention also relates to a device obtained by such a method for production.

The known techniques for design or for production of such image recording and/or reproduction devices, such as digital or argentic cameras, video projectors or image projectors, consist of initially choosing the properties of the material elements of the device, in particular the optical image system for visualisation or projection, the image recorder or generator and the synchronisation system. Subsequently, where necessary, provision is made for the means for digitally processing images in order to correct defects of at least one of the material elements of the device.

In particular, to design a device's optical system, the first step is to establish a schedule of technical specifications, that is to say the bulk, the focal ranges, the aperture ranges, the field image, the performances expressed either in spot size or in MTF (modulation transfer function) values, and the cost are specified. From this schedule of technical specifications, a type of optical system is selected and, using a software tool of optical calculations, such as the “Zemax” tool, the parameters of this system are selected which best correspond to the schedule of specifications. This definition of the optical system is done interactively. In general, an optical system is designed in a way which presents the best central image quality and, usually, the quality of the image edge is of an inferior quality.

Furthermore, the usual techniques are such that the optical system is designed in such a way as to obtain a determined level of distortion, of vignetting and of blur, in order that the optical system can be compared to other optical systems.

Moreover, for digital photographic devices, the characteristics of the sensor, namely: the pixel quality, the pixel area, the number of pixels, the microlens matrix, the anti-aliasing filters, the pixel geometry and the disposition of pixels are also selected.

The usual technique consists of selecting the sensor of an image recording device independently of the other elements of the device and, particularly, of the image processing system.

An image sensor or generating device also usually comprise one or several synchronisation systems such as an exposure system and/or a focusing system “autofocus”

Thereby, to specify an exposure system which controls the aperture and exposure time, and possibly the sensor gain, the means of measuring are determined, in particular the image zones on which the exposure will be measured as well as the affected weight of each zone.

For a focusing system, the number and the position of image zones which will be used when focusing are determined. Settings are also specified, for example, a motor speed setting.

In all cases, these specifications are applied regardless of the presence of a digital means of image processing.

The invention derives from an observation that these classical techniques for the design and creation of devices do not permit that full advantage can be taken of the possibilities offered by the means for digitally processing images.

Thereby, the invention concerns, generally, a method for production of an image recording and/or reproduction device comprising an optical image recording and/or reproduction system, an image sensor and/or generator and/or a synchronisation system, said image being processed for improvement by digital image processing means;

A method in which parameters of the optical system and/or the image generator and/or the synchronisation system are determined or selected from the capacities of the digital image processing means. The production costs are thus minimised and/or the production of the image recording and/or reproduction device is optimised.

It is noted that the deliberate degradation of the distortion characteristics of an optical system in favour of the correction of other aberrations, the distortion being corrected using a system for digital image processing is already known. With such an optical system, which relaxes the constraints of distortion, provision can be made for a lower number of surfaces and, therefore, a reduction in costs. Alternatively, performance can be increased without increasing the total cost. It is equally possible to obtain systems with a wider angle.

But the current technology neither demonstrates nor suggests satisfactory solutions to the diverse problems which are resolved by the invention, in particular:
optimising the aperture of an optical system of an image recording or reproduction device. The term “optimising” refers to, in relation to a classic device, increasing the aperture without increasing the cost, or maintaining an acceptable aperture while reducing the cost of the device or, generally, providing the choice of aperture parameters, cost and performance.

Thereby, according to the first of these aspects, the invention concerns a method for production of an image recording and/or reproduction device comprising an optical image recording and/or reproduction system, an image sensor and/or generator and/or a synchronisation system, said image being processed for improvement by digital image processing means,
the method being such that the digital image processing means includes its own means of correction for correcting at least one of the characteristics included in the group comprising the blur, the variable blur according to the position in the field of image, the depth of field, the variable depth according to the position in the field of image and the vignetting,
and the method being such that the aperture of the optical system is optimised, in particular at a fixed focal length, to take into account the means of correction.

In one embodiment, the method is such that the digital image processing means further include, in the known way, the means for distortion correction.

Generally, it is noted that even though the method according to the invention calls upon the means for distortion correction, it concerns the production of a device in which at least one parameter of the optical image recording and/or reproduction system and/or the synchronisation system based on the capacities of the digital image processing means other than the correction of distortion is determined or chosen.

In one embodiment, for which provision is made for the means of both blur and vignetting correction, in relation to a classic optic the vignetting and the central clarity are degraded in order to obtain, in terms of overall consistence of quality, a superior aperture.

In one embodiment, which can be used independently of the first aspect of the invention mentioned herewith, the optical system is of a variable focal length, furthermore the method is such that:

The digital image processing means include the means for correction of lateral chromatic aberrations and/or of blur, and/or of vignetting, and/or of noise and/or of parallax compensation, and
at least one parameter of the optical system is determined or chosen taking into account the digital image processing means, in the group comprising the following parameters:
the number of optical elements of the system, the nature of the materials constituting the optical elements of the optical system, the cost of materials of the optical system, the treatment of optical surfaces, the colour of materials of the optical system, the assembly tolerances, the value of the parallax according to the focal length and the characteristics of focusing.

According to yet another of its aspects, which can be employed independently from the other aspects mentioned herewith, the invention concerns a said method of embodiment of an image recording and/or reproduction device comprising an optical image recording and/or reproduction system, an image sensor and/or generator and/or a synchronisation system, said image being processed for improvement by digital image processing means,

The method being such that at least one parameter of the image sensor and/or generator and/or of the synchronisation system from the capacities of the digital image processing means, is determined or chosen.

### Definitions

Significations of the diverse terms employed are hereby defined:
An image recording device is, for example, a disposable camera, a digital camera, a reflex camera (digital or not), a scanner, a fax, an endoscope, a camera, a video camera, a security camera, a game, a camera or photographic device integral or linked to a telephone, a personal assistant or a computer, a thermal camera, an ultrasound device, an MRI (magnetic resonance) imaging device, a radiography X-ray device.
An image reproduction device is, for example, a screen, a projector, a television, virtual reality goggles or a printer.
An image recording and reproduction device is, for example, a scanner/fax/printer, a mini photo lab, a video conferencing device.
The term optical image recording system refers to the optical means permitting the reproduction of images on a sensor.
The term optical image reproduction refers to the optical means permitting the forming of images on a screen or the reproduction for the observer of an image already on a screen. It is also possible to reproduce an image without the use of a screen.
The term screen refers to all physical mediums on which an image can be formed.
The term image sensor refers to the mechanical, chemical or electronic means permitting the capture and/or recording of an image.
The term image generator refers, for example to the circuits of a television receiver, a quartz crystal screen, the printing means of a printer, the control system of a means of micro mirror projector.
The term synchronisation system refers to means of a mechanical, chemical, electronic or computerised type permitting that the elements or parameters of the device conform to a setting command. It refers in particular to the automatic focusing system (autofocus), to the automatic white balance control, to the automatic exposure control, to the control of optical elements, in order, for example to preserve a uniform quality of images, to an image stabilising system, to an optic and/or digital zoom factor control system, or to a saturation control system or to a contrast control system.

The term digital image processing means refers, for example, to a software programme and/or a component and/or equipment and/or a system permitting the modification of an image.

Digital image processing means can be completely or partially integral to the device, as in the following examples:
An image recording device which produces modified images, for example a digital camera with integrated means for image processing
An image reproduction device which displays or prints modified images, for example a video projector or a printer including the means for image processing.
A mixed device which corrects faults in its elements, for example a scanner/printer/fax including the means for image processing.
A professional image recording device which produces modified images, for example an endoscope including the means for image processing.

In the case where the digital image processing means are integral to the device, in practice the device corrects its own fault.

When using a set of devices, for example a fax with a scanner and a printer, the user can, however, use only part of the set of devices, for example, if the fax can also be used as a stand alone printer; in this case, the digital means for image processing must each correct their own faults.

The digital means for image processing can be totally or partially integral to a computer, for example in the following way:
In an operating system, for example of the make Windows or Mac OS, to automatically modify the quality of images originating from, or destined for, several different types of device which vary according to the image and/or the time, for example scanners, cameras, printers. The automatic correction can take place, for example, during the entering of the image into the system, or when a user makes a print request.
In one application of image processing, for example Photoshop™, to automatically modify the quality of images originating from, or destined for, several different devices according to the image and/or the time, for example scanners, cameras, printers. The automatic correction can take place, for example when the user activates a filter command in Photoshop™.
In a photo developing device (for example “photofinishing” or “Minilab”), for automatically modifying the quality of images originating from various different photographic devices according to the image and/or the time, for example disposable devices, digital cameras, compact discs. The automatic correction can take into account photographic devices as well as the integral scanner and printer and take place at the moment when the printing operation is implemented.
On a server, for example on the Internet, for automatically modifying the quality of images originating from various different photographic devices according to the image and/or at the time, for example disposable devices, digital cameras, compact discs. The automatic correction can take into account photographic devices as well as, for example, a printer and take place at the moment when the images are recorded on the server, or at the moment when the printing operation is implemented.

In the case where the digital image processing means are integral to a computer, in practice the digital image processing means are compatible with multiple devices, and at least one device in a set of devices can vary from one image to another.

In one embodiment, the levels of performances of the optical system and/or the image sensor and/or generator, and/or the synchronisation system are adjusted, in particular the average performance levels, in terms of the performance of digital image processing means.

Thereby, the overall level of performances being dictated by the part of the device which presents the weakest level of performance, a priori the level of performance is fixed according to the capacities of the digital image processing means and the optical system, the image sensor or generator and/or the synchronisation system are chosen which have inferior performances but which can meet the levels determined by the digital image processing means.

The performances of a device are in particular, its cost, its dimensions, the minimum quantity of light it can receive or emit, the quality of the image and the technical qualities of the optic, of the sensor and the synchronisation. The performances of the digital image processing means are the limits of its capacity and its means.

According to one embodiment:
the digital image processing means comprise a means for improving the quality of the image by acting on at least one of the parameters of the group comprising: the geometric distortions of the optical system, the chromatic aberrations of the optical system, the compensation of the parallax, the depth of the field, the vignetting of the optical system and/or image sensor and/or generator, the lack of clarity of the optical system and/or the image sensor and/or generator, the noise, the moiré phenomenon and/or the contrast,
and/or at least one determined or selected parameter of the optical system is chosen from the group comprising: the number of optical elements of the system, the nature of the materials constituting the optical elements of the optical system, the cost of materials of the optical system, the treatment of the optical surfaces, the assembly tolerances, the value of the parallax according to the focal length, the characteristics of the aperture, the mechanism of the aperture, the possible focal range, the focusing characteristics, the focusing mechanisms, the anti-aliasing filters, the dimensions, the depth of the field, the characteristics linking the focal length and the focusing, the geometric distortions, the chromatic aberrations, the decentering, the vignetting, the clarity characteristics,
and/or at least one determined or selected parameter of the image sensor and/or generator is chosen from the group comprising: the pixel quality, the pixel area, the number of pixels, the microlens matrix, the anti-aliasing filters, the pixel geometry, the disposition of pixels,
and/or at least one determined or selected parameter of the synchronisation system is chosen from the group comprising: the measurement of focusing, the measurement of exposure, the measurement of white balance, the focusing settings, the exposure settings and the sensor gain settings.

The capacities of the digital image processing means are, for example, defined in the following way:
for geometric distortion, the maximum percentage of distortion which can be corrected is specified.
for chromatic aberrations of the optical system the maximum dispersion value, in number of pixels, between the different colour spots, which can be corrected by the digital image processing means is specified.

The compensation of the parallax is the maximum value of the parallax which can be corrected by the digital image processing means. This value is, for example expressed in the number of pixels. It is noted that when the focal distance varies, the position of the optic centre can change and thus cause a change in the parallax. The parallax is the variation of the position of the optic centre which intervenes when the focal distance varies.

Clarity is measured, for example, in values which are denominated as BXU which is a measurement of the surface of the blur spot, as is described in the published article in the “Proceedings of IEEE, International Conference of Image Processing, Singapore 2004”, entitled “uniqueness of Blur Measure” by Jerome BUZI and Frederic GUICHARD.

In simple terms, the blur of an optical system is measured in the image, called “impulsive response”, from an infinitely small point situated in the plane of sharp focus. The BXU parameter is the variation of the impulsive response (that is to say its average surface). The processing capacities can be limited to a maximum value of BXU.

The digital image processing means can be specified for the distinctive correction of the various causes of lack of clarity, in particular, to take into account the symmetry of blur spots. For example, an astigmatic blur spot presents two axes of perpendicular symmetry, whilst a “comma” type blur spot presents only one perpendicular axis.
the depth of field is defined as being the distance between the closest subject and the furthest subject in which the blur spot does not exceed its predetermined dimensions. To increase the depth of field, the digital image processing means reduces the dimensions of the blur spot.

Vignetting is the variation in light in the field of image. For example, the maximum authorised percentage of vignetting in the image is specified.

The noise is specified, for example in its gap type, its shape, the dimensions of the noise spot as well as its coloration.

The moiré phenomena appear in spatial high frequencies. They are corrected using anti-aliasing filters. The digital image processing means are specified by the anti-aliasing filter parameters.

It should be noted that anti-aliasing filtering can be carried out, either by optical or digital means.

For the contrast, the digital image processing means are specified by the minimum value of the amplitude of variations in contrast which can be improved.

Concerning the optical system parameters, it should be remembered that decentering is an optical system property which allows for the correction of perspective effects.

Concerning the image sensor and/or generator: the term “quality of pixels” refers to the sensitivity, the yield and the image noise produced by each pixel, as well as the group of colours which can be captured and/or feasibly reproduced. The dynamics of the capturable signals by the pixels also constitutes one of their qualities.

For the synchronisation system which allows for automatic focusing, it is noted that focusing can be effected in different ways, in particular, by controlling the position of mobile elements of the optical system or by controlling the geometry of the deformable optical elements.

In one embodiment, at least one parameter of the image sensor or generator is determined or chosen, in particular the dimensions, using the digital image processing means which comprise the means to reduce noise. It is therefore, possible to obtain a given level of noise for a given quantity of light, whilst reducing the cost of the sensor.

It is noted that the classic technique for the design of an image sensor and/or generating device consists of choosing an optical system and a sensor or generator and, subsequently, reducing the noise but within the limits of the available calculating power.

In one embodiment, taking into account the capacities of the digital image processing means, the characteristics of the optical system and device are firstly determined, in particular the dimensions, the blur, the characteristics of colour, contrast, noise, details, secondly the characteristics of the optic are determined taking into account the capacities of the image processing, as well as the characteristics of the image sensor or generator, in particular the number of pixels.

In one embodiment, the optical system is preferably of a fixed focal length and its aperture is optimised for taking into account the digital image processing means which comprise the means for correction of blur, in particular variable in accordance with the position in the field of image, and/or the means for correcting the vignetting and/or the means for correcting distortions.

It is thereby possible to maximise the aperture of the optical system. In relation to an image recording device which has no means for correction, it is also possible to use:
less sensitive sensors, in particular with smaller pixels and, therefore, sensors with a smaller given number of pixels in order to reduce the bulk,
or shorter exposure times, which reduces the movement blur,
or extend the limits on the use of the device and provide the same quality of image using less light.

In one embodiment, the device includes a synchronisation system which notably permits control of focusing, and the digital image processing means comprise the means for correction of blur and/or the means for correction for the depth of field, the parameters of the optical system, in particular the position of the image plane function of the focusing distance and/or of the focal distance, are determined or chosen in such a way as to ensure that the clarity of images is noticeably homogeneous in the image field.

Thereby, maximum clarity is not necessarily sought before digital processing in the image zone which serves as the focus. In this case, in one embodiment, the focusing point is practically independent from the image serving as the focal point whereas normally, because of the variable curving in the field of image the focusing distance varies with the focusing zone.

Thereby, the measurement of the focusing takes into account the ulterior correction. For example the measurement takes into account the position in the field and of the level of correction of blur function of the position in the field. It is not sought therefore to obtain maximum clarity for the brut measurement as with a classic device but for the measurement which has been corrected in this way.

The setting for focusing also takes into account the capacities of correction. A certain level of blur is acceptable which depends on the focal distance and the known capacities for correction, and maximum clarity is not sought during focusing as with a typical device.

The maximum level of blur in the field is therefore lower, and the minimum level in the field can be higher than in a typical device and is adapted to the capacities of the means for processing the image.

The variation in the blur level when the focal length varies without changing the focal point can therefore be greater than in a classic device, which permits the simplification of the optic and, therefore, a reduction of costs, since the synchronisation system of the focusing can take into account the focal distance and adapt the focusing when the focal distance varies.

In one embodiment, the device comprises an exposure synchronisation system and the exposure parameters of this synchronisation system are determined or chosen by taking into account the capacity for correction of the correction algorithms of noise and/or contrast and/or movement blur being part of the digital image processing means, for example to obtain, after correction, a given level in terms of noise, contrast and blur.

When noise is corrected, it is possible, for the same quality of image, to call for a higher sensitivity in relation to a situation where noise correction is not called for.

Thereby, the measurement of exposure taking into account the capacities for ulterior correction, which, for example, diminish noise by four, it is possible to set a shorter exposure time in order to avoid movement blur and/or set a higher sensor gain to enable shots in low light or to reduce the aperture and increase the field depth. In other words, the advantages are greater latitude of choice of exposure parameters. In brief, in relation to existing systems, shorter exposure times, apertures which are more closed and greater gains in the quantity of light given in the scene can be chosen.

When contrast is corrected, it is possible, for the same quality of image, to call for a lower sensitivity in relation to a situation where contrast correction is not called for.

When contrast is corrected, the exposure measurement taking into account the ulterior capacities for correction, can call for a lower sensor gain for those images which have dark zones than for those which do not have them, in the sense that the parts which are in the dark zones are correctable by the contrast correction algorithms at the cost of an increase in noise.

According to one embodiment:
the digital image processing means comprise the means for correction of lateral chromatic aberrations and/or blur, and/or distortion, and/or vignetting, and/or noise, and/or compensation of the parallax.
the optical system is of a variable focal distance, and
the parameters of this optical system are determined or chosen from the group comprising the following parameters: the number of optical elements of the system, the nature of the materials constituting the optical elements of the optical system, the cost of the materials of the optical system, the treatment of the optical surfaces, the colour of the materials of the optical system, the assembly tolerances, the value of the parallax according to the focal distance and the characters of the focusing.

Thereby, with the digital image processing means carrying out corrections a priori and/or appropriate compensations, it is possible to optimise, in particular by minimising, the number of optical elements of the optical system, it is possible to optimise the nature of the materials of the optical system, to reduce the cost and to optimise the treatment of optical surfaces. The colour of the materials of the optical system can be chosen at will, in as much as the means for correcting colours are prescribed. Assembly tolerances can be relaxed. The variation values admitted by the parallax in accordance with the focal distance can be increased, and it is also possible to relax the focusing characteristics.

The possibility of compensating the variations of the parallax constitute an important advantage for video devices, both amateur and professional (or other animated image recording devices) since, in these applications, it is important to keep a quasi constant parallax when the focal distance or the focusing varies in such that movement interference of the image is undetectable to the eye.

With the invention, conversely to usual optics, a variation of the parallax is permitted which is compensated by the digital processing means.

Furthermore, it is known that a zoom type objective permits variable focal distances whilst conserving, for diverse focal distances, the same focusing. A zoom type objective is, therefore, relatively onerous since it must respect this constraint of having to keep the focus for a diverse value of focal distances. The invention, in allowing the relaxing of focusing characteristics, permits the production of a less onerous zoom with the same performances, the focusing characteristics being compensated by the digital image processing means. In other words, the zoom can be produced at a cost which can be close to that of a “varifocal” objective, that is to say of an objective which does not require the maintaining of focusing when the focal distance varies.

According to one embodiment, the dimensions of the device are determined according to the capacities of the digital image processing means.

Notably, it is possible to minimise the bulk of the device. In particular, the sensor can be of reduced dimensions. It is possible to reduce the size of pixels, within the limits of the capacities of the digital image processing means for correcting the faults resulting from a smaller size of pixel and in particular the resulting increase of noise. Also, it is possible to reduce the size of pixels and increase the aperture of the optic within the limits of the capacities of the digital image processing means for correcting the faults resulting from an increase in the aperture of the optic and notably the resulting increase in blur. In the same way, it is possible to minimise the bulk of the optical system by making provision for a number of lenses which render the bulk inferior to the focal distance, on condition that the digital image processing means are prescribed for correcting the faults resulting from there being a large number of optical elements. The dimensions of the synchronisation system can also be reduced, the digital image processing means permitting, for example the minimising of the displacement of the optical elements of the optical system and therefore energy consumption, which brings about a reduction of the electrical energy volume of powering batteries as well as the synchronisation motors.

In one embodiment, the digital image processing means are at least partially included in the image recording and/or reproduction device.

The digital image processing means can also be at least partially separate from the image recording and/or reproduction device as in the case, for example, as explained herewith, where the digital image processing means are in a computer.

According to one embodiment, the choosing of parameters of the optical system consists of selecting the optical system from amongst pre-existing systems. It is also possible to choose the parameters of the sensor or generator by selecting the sensor or generator from amongst pre-existing systems.

For example, it is possible to choose simple pre-existing optical systems, in particular with a minimum number of lenses and, therefore, less onerous, the digital image processing means compensating for the faults which bring about the simplicity of the optical system.

In one embodiment, the digital image processing means comprise the means for acting upon the lack of clarity of the optical system and/or the image sensor and/or the generator and these means are such that they permit the production of an image recording and/or reproduction device which does not have a synchronisation system permitting focusing.

In other words, it is not necessary to displace or deform the optical elements to achieve focus if the means for correction of clarity can obtain a sufficiently clear image without means of focusing.

For example, if a fixed focal image recording device can obtain clear images of 80 cm to infinity, this device being without an automatic focusing system, and where using a sensor which has a greater number of pixels whilst conserving the same qualities of clarity (of 80 cm to infinity), without calling upon an automatic focusing system, provision is made for the digital image processing means which reduce the size of the blur spot in order to achieve the required result. As a further example, it is possible to produce, starting from digital image processing means which reduce the size of the blur spot, a recording device with a wider aperture, for example by going from 2.8 to 1.4, whilst conserving the same depth of field.

According to one embodiment: an overall schedule of specifications is defined for the device, as is, correlatively, notably in an interactive way, a schedule of specifications for the optical system and/or a schedule of specifications for the image sensor and/or generator and/or a schedule of specifications for the synchronisation system, and an overall schedule of specifications for the digital image processing means,

In order that the transfer of performances of the schedule of specifications of the optical system, and/or the schedule of specifications of the image sensor and/or generator, and/or the schedule of specifications of the synchronisation system to the schedule of specifications of the digital image processing means is possible, and/or in order that the method permits the reduction of production costs for the device.

The term schedule of specifications for a device, or of one of its components, or the digital image processing means refers to the group of technical specifications which the device, its components or the digital image processing means must conform to.

In one embodiment, the image recording and/or reproduction device comprises a synchronisation system and at least one parameter of the image sensor and/or generator and/or of the synchronisation system is chosen from amongst the capacities of the digital image processing means.

In one embodiment, the optical system is a zoom lens.
the digital image processing means comprise the means for correction for at least one of the characteristics included in the group comprising the blur, the vignetting, the noise and the compensation of the parallax, and
at least on parameter is determined or chosen of the optical system in the group comprising: the number of optical elements of the optical system, the nature of the materials constituting the optical elements of the optical system, the cost of the materials of the optical system, the treatment of the optical surfaces, the colour of the materials of the optical system, the assembly tolerances, the value of the parallax according to the focal length, and the characteristics of the focusing.

In one embodiment:
the digital image processing means comprise a means for improving the quality of the image by acting on at least one of the parameters of the group comprising: the vignetting of the image sensor and/or generating device, the lack of clarity of the image sensor and/or generating device, the noise, the moiré phenomena, and/or the contrast,
and/or at least one parameter is determined or chosen of the image sensor and/or generating device in the group comprising: the quality of pixels, the area of the pixels the number of pixels, the microlens matrix, the anti-aliasing filters, the geometry of the pixels, the disposition of the pixels,
and/or at least one parameter is chosen of the synchronisation system relative to at least one element of the group comprising: the measurement of focusing, the measurement of exposure, the measurement of the white balance, the focusing settings, the aperture settings, the exposure time settings, the sensor gain settings.

In one embodiment, at least one parameter is determined or chosen of the image sensor or generator relative to the dimensions of the sensor or generator, the digital image processing means comprising the means for reducing noise permitting the minimisation of the dimensions of the image sensor or generator.

In one embodiment in which the device comprises an synchronisation system, at least one parameter of the optical system, in particular the position of the image plane function of the focusing distance and/or of the focal distance, is determined or chosen in such a way as to ensure that the clarity of images is noticeably homogeneous in the image field, the synchronisation system taking into account the position of the image plane function of the focusing distance and/or of the focal distance.

In one embodiment for which the device comprises a synchronisation system, at least one parameter of the synchronisation system, in particular the exposure parameters, is determined or chosen taking into account the capacity for correction of the correcting algorithms of noise and/or contrast and/or movement blur being part of the digital image processing means.

In one embodiment, the digital image processing means comprise the means for acting upon the lack of clarity of the optical system and/or the image sensor and/or generator, these means being such that they permit the production of image recording and/or reproduction devices which do not have a focusing synchronisation system.

In one embodiment, the dimensions of the device are determined according to the capacities of the digital image processing means.

In one embodiment, the digital image processing means are at least partially included in the image recording and/or reproduction device.

In one embodiment the digital image processing means are at least partially separate from the image recording and/or reproduction device.

In one embodiment, the optical system is selected from amongst pre-existing optical systems.

In one embodiment, the sensor or generator is selected from amongst pre-existing optical systems.

In one embodiment, the digital image processing means comprise a means for improving the quality of the image by acting on at least one of the parameters of the group comprising: the vignetting of the optical system and/or of the image sensor and/or generator, the lack of clarity of the optical system and/or of the image sensor and/or generator, the noise, the moiré phenomena, and/or the contrast.

In one embodiment, at least one parameter is determined or chosen of the optical system from the group comprising: the number of optical elements of the system, the nature of the materials constituting the optical elements of the optical system, the cost of the materials of the optical system, the treatment of optical surfaces, the assembly tolerances, the values of the parallax according to the focal distance, the characteristics of the aperture, the mechanisms of the aperture, the possible focal range, the focusing characteristics, the focusing mechanisms, the anti-aliasing filters, including, the depth of field, the characteristics linking the focal distance and the focusing, the geometric distortions, the chromatic aberrations, the decentering, the vignetting, the clarity characteristics.

The invention also concerns an image recording and/or reproduction device obtained by the method of production defined herewith.

Other characteristics and advantages of the invention appear with the descriptions of some of the embodying modes, this being done by reference to the drawings annexed herewith on which:

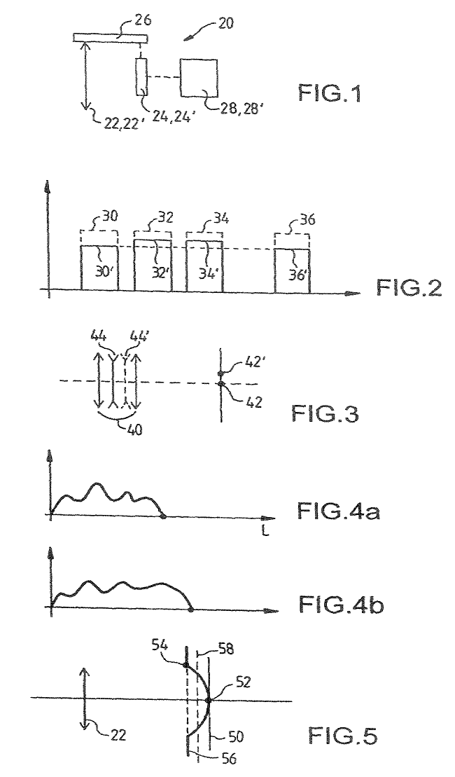

FIG. 1 is a scheme of the device obtained by the method according to the invention,

FIG. 2 is a diagram showing the stages of the method according to the invention,

FIG. 3 shows a mode of adjustment in accordance with the invention,

FIGS. 4a and 4b form the group of diagrams showing the adjustments used in the frame of the invention,

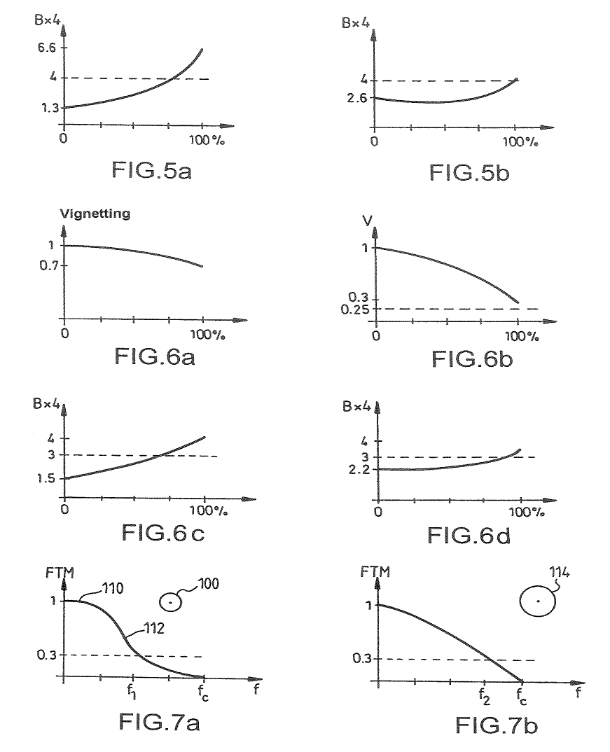

FIGS. 5, 5a and 5b illustrate a property of an image recording device according to the invention and a conventional device,

FIGS. 6a to 6d are diagrams showing the properties of an optical system of a device according to the invention and of a classic device, and

FIGS. 7a and 7b are schemas showing an example of the selection of an optical system for a device according to the invention.

FIG. 1 is a schema illustrating the architecture of an image recording and/or reproduction device.

Such a device, for example for image recording, includes, in part, an optical system 22, notably of one or several optical elements such as lenses, destined to form an image on a sensor 24.

Although the examples mainly concern a sensor 24 of an electronic type, this sensor can be of another type, for example a photographic film in the case of an “argentic” device.

Such a device also comprises a synchronisation system 26 acting on the optical system 22 and/or on the sensor 24 in order to focus so that the image plane is found in the sensor 24, and/or so that the quantity of light received in the sensor is optimised by the exposure settings and/or the aperture, and/or so that the colours obtained are true, by using the synchronisation of white balance.

Finally, the device includes digital image processing means 28.

Alternatively, the digital image processing means are separate from the device 20. It is also possible to allow for a part of the digital image processing means inside the device 20 and a part outside.

Digital processing of the image is done after images have been recorded by the recorder 24.

A reproduction device presents an analogous structure to an image recording device. In place of a sensor 24, there is an image generator 24′ receiving the digital image processing means 28′ and supplying the images to an optical system 22′, such as an optical projection system.

In the following, for the clarity of the exposure, reference is only taken from image recording devices.

The invention consists of the capacities of the digital image processing means 28, 28′ for determining or choosing the parameters of an optical system 22, 22′, and/or of an image sensor and/or generator 24, 24′ and/or of a synchronisation system 26.

The diagram in FIG. 2 represents the level of performances that can be expected from each of the components of the device when they are associated to the digital image processing means. These levels are represented by the dotted line 30 for the optical system, the dotted line 32 for the sensor, the line 34 for the synchronisation, and the dotted line 36 for the device.

Starting from these performance levels that can be obtained with the digital image processing means, the levels of performance can be chosen for each of the components of the device which are before processing, considerably inferior to the performance levels obtained after the application of the digital image processing means. In this way it is observed that the performance levels of the optical system can be established at level 30′, the performance levels of the sensor and of the synchronisation system can be established at levels, respectively 32′ and 34′.

In these conditions, in the absence of digital image processing, the level of performances of the device will be at the lowest level, for example level 36′ corresponds to the lowest level 30′ for the optical system.

The digital image processing means are preferably those which are described in the following documents:
Patent application EP 02751241.7 entitled:

“Method and system for producing formatted information related to defects of appliances in a set of appliances and formatted information destined for image processing means”.
Patent application EP 02743349.9 for: “Method and system for modifying the qualities of at least one image coming from or destined for a set of appliances”.
Patent application EP 02747504.5 for: “Method and system for reducing the frequence of updates in image processing means”.
Patent application EP 02748934.3 for: “Method and system for correcting chromatic aberrations of a colour image produced using an optical system”
Patent application EP 02743348.1 for: “Method and system for producing formatted information related to geometric distortions”.
Patent application EP 02748933.5 for: “Method and system for supplying, according to a standard format, formatted information to image processing means”.
Patent application EP 02747503.7 for: “Method and system for calculating an image transformed from a digital image and for formatted information relating to a geometric transformation”
Patent application EP 02747506.0 for: “Method and system for producing formatted information related to defects of at least one appliance in a set, in particular of blur”.
Patent application EP 02745485.9 for: “Method and system for modifying a digital image taking into account its noise”.
Patent application PCT/FR 2004/050455 for: “Method and system for differentially and regularly modifying a digital image by pixel”.

These digital image processing means permit the improvement of the image quality by acting on at least one of the following parameters:
Geometric distortions of the optical system. It is noted that an optical system can distort images in such a manner that a rectangle can be deformed into a cushion, with a convex shape to each of its sides or into a barrel with a concave shape to each of its sides.
Chromatic aberrations of the optical system: if an objective point is represented by three coloured spots having precise positions in relation to each other, the chromatic aberration is translated by a variation in the position of these spots in relation to each other, the aberrations being, in general, even more important when distanced from the centre of the image.
The parallax: when carrying out an adjustment by deformation or displacement of an optical element of the optical system, the image obtained on the image plane can move. The adjustment is, for example, an adjustment to the focal distance, or an adjustment to the focusing.

This defect is illustrated by FIG. 3 on which an optical system 40 is represented with three lenses in which the centre of the image has position 42 when the lens 44 has the position represented by a full line. When the lens 44 moves into position 44′, represented by dotted lines, the centre of the image takes the position 42′.

Depth of field: when the optical system is focused on a selected object plane, the images of this plane remain clear as well as the images of the objects close to this plane. “Depth of field” refers to the distance between the nearest object plane and the object the furthest away which remain clear in the image.
Vignetting: in general, the luminosity of the image is at a maximum at the centre and progressively diminishes towards the edges. Vignetting is measured in the distance, in percentage, between the luminosity of one point and the maximum luminosity.
Lack of clarity of the optical system and/or the image sensor and/or generator is measure for example by the BXU parameter such as is defined herewith.
Image noise is generally defined by its gap type, its shape and the dimension of the noise spot and its coloration,
The moiré phenomenon is a deformation of the image which occurs due to the existence of spatial high frequencies. The moiré is corrected by the parametering of anti-aliasing filters.
Contrast is the relation between the highest and the lowest luminosity values of the image for which the details of the image remain visible.

As is represented in FIGS. 4a and 4b, it is possible to improve the contrast (FIG. 4a) in an image, that is to say extend (FIG. 4b) the range of luminosity on which it is possible to distinguish details. This extension is done using in particular a correcting algorithm of contrast and of noise.

A description of an embodiment permitting uniformity of clarity in the field of image is described in relation to FIG. 5.

It is firstly noted that the image surface of an object plane does not constitute a perfect plane but a curves known as a field curve. This curve varies according to diverse parameters including the focal distance and the focusing. Thereby, the position of the image plane 50 depends on the zone on which the focusing is carried out. In the example represented on FIG. 5, the plane 50 corresponds to a focus on the centre 52 of the image. For a focus on a zone 54 close to the edge of the image, the image plane 56 can be found closer to the optical system 22 than to the image plane 50.

To simplify the focus synchronisation system, the image plane is in a position 58, intermediately between positions 54 (corresponding to a focus on a zone close to the edge of the image), and 50 (corresponding to a focus on a zone in the centre of the image). The union of the digital image processing means 28 with the focus synchronisation 26, permits the limitation of movement of the plane 58 for focusing, which reduces energy consumption by the synchronisation system and permits a reduction in volume of its components.

Represented on the diagram in FIG. 5a are the blur properties of a classic focus synchronisation system in which the maximum clarity is obtained at the centre of the image. Thereby, on this diagram in FIG. 5a the abscissa represents the field of image and the ordinate the blur value expressed in BXU. With this classic focus synchronisation system, the blur is, in the centre, 1.3 and, at the edge of the image, 6.6.

FIG. 5b is an analogous diagram of that which is in 5a showing the synchronisation properties of a device produced according to the invention, starting from the hypothesis that the digital image processing means permit the correction of blur up to a BXU value equal to 4. The curve represented on this diagram in FIG. 5b thus presents, in the centre of the image, a BXU value=2.6 and the BXU value diminishes on moving away from the centre then goes back up to a value of 4 towards the edge of the image. It is herewith noted that this value is the limit at which the blur is correctable using digital processing means. Thereby a clear image can be obtained throughout the field of image whereas this is not possible with a device fitted with a classic system.

In one embodiment, the digital image processing means include the means for improving clarity which negate the need for a synchronisation of focusing.

As a comparable example, the diagrams in FIGS. 6a, 6b, 6c and 6d show the characteristics of a device obtained using the classical technique and that obtained according to the invention.

The classic device is a digital photographic device integral with a mobile phone having a VGA sensor, that is to say a resolution of 640×480 without a focusing system.

The classic device has an aperture of 2.8 whereas the device obtained with the method according to the invention has an aperture of 1.4.

FIG. 6a, which corresponds to the classic device is a diagram on which the abscissa represents the percentage of the field of image, the origin corresponding to the centre of the image. The ordinate represents the vignetting V. FIG. 6b is an analogous diagram for a device obtained according to the invention.

In the schema of FIG. 6a (classic device) the vignetting attains a value of 0.7 at the edge of the image whereas in the diagram in FIG. 6b it is observed that the optical system of the device according to the invention, presents a vignetting which is considerably greater, in the order of 0.3. The limit of correction of the employed algorithm is 0.25. In other words, thanks to a correcting algorithm it is possible to call upon an optic with considerably greater vignetting.

FIG. 6c is a diagram in which the ordinate represents the blur, expressed in BXU, according to the field of image (the abscissa) for a classic device. In this classic device, the blur characteristic is 1.5 at the centre and 4 at the edge of the image.

The diagram in FIG. 6d also represents the blur for the optical device obtained with the method according to the invention. On the abscissa of the diagram in FIG. 6d is also represented the field of image and on the ordinate the blur expressed in BXU. It can be observed on this diagram in FIG. 6d that the blur at the centre of the image is in the order of 2.2. It is therefore, higher than the blur in the diagram in FIG. 6c. Conversely, at the edges, a blur has been chosen in the order of 3, taking into account the limit of the correcting algorithm.

In other words, surprisingly, a degraded optic was chosen concerning the clarity at the centre, whereas it is possible to obtain the same results only with a classic device, with, what is more, a larger aperture. It is also to be noted that at the edges, the optic of the device according to the invention represents an analogous quality to that of the classic optic, this result can be obtained because of the degradation of the vignetting in comparison to a classic optic.

The diagrams in FIGS. 7a and 7b represent the different characteristics of the optical systems between which the choice must be made in order to produce a recording device when using the method according to the invention.

In the example represented in FIG. 7a, the optical system supplies a 100 spot image of small dimensions. This system presents a modulation transfer function (MTF) represented by a diagram where the spatial frequencies are shown in the abscissa. The value of the cut-off frequence is fc. The MTF function includes a 110 threshold around the zero frequence and a rapidly decreasing part towards the fc value.

The optic represented by the schema in FIG. 7b, presents a 114 spot image of dimensions considerably superior to the 100 spot image and its MTF presents the same fc cut-off frequence as in the case of FIG. 7a. Conversely, the variation of this MTF according to the spatial frequence is different: this frequence diminishes relatively evenly going from the origin towards the cut-off frequence.

The choice of an optical system is based on the fact that the correction algorithm of the modulation transfer function is effective from a value of 0.3. In these conditions, it is observed that with the optic in FIG. 7b a correction is obtained which permits a rise in the MTF to a value of f₂, for example, in the order of 0.8 fc whereas with the optic in FIG. 7a, correction is only possible to a frequence f₁ in the order of 0.5 fc.

In other words, with a correcting algorithm, the optic represented in FIG. 7b supplies more detail than the optic represented in FIG. 7a, and this in spite of the fact that the image spot is of greater dimensions than in the case of FIG. 7a. The optic corresponding with FIG. 7b would therefore be chosen.

1-19. (canceled)

20. A method of production of an image recording and/or reproduction device including an optical system to record and/or reproduce images, an image sensor and/or generator, the image being processed, for improvement, by a digital image processing means, the digital image processing means incorporating means of correction to correct at least one of characteristics included in the group comprising blur, variable blur according to a position in a field of the image, depth of the field, variable depth of the field according to the position in the field of the image, and vignetting, the method comprising:
optimizing an aperture of the optical system, notably at a fixed focal length, to take into account the means of correction.

21. A method according to claim 20, in which the digital image processing means further incorporates means of correction of distortion.

22. A method according to claim 20, in which the image recording and/or reproduction device further includes a synchronization system, and wherein at least one parameter of the image sensor and/or generator and/or of the synchronization system is determined or selected from capacities of the digital image processing means.

23. A method according to claim 20, in which the optical system is a zoom lens,
the digital image processing means incorporates the means of correction of at least one of the characteristics included in the group comprising blur, vignetting, noise, and parallax compensation, and
at least one parameter is determined or chosen of the optical system in the group comprising: a number of optical elements of the system, nature of a material constituting the optical elements of the optical system, cost of materials of the optical system, treatment of optical surfaces, color of the materials of the optical system, assembly tolerances, a value of parallax according to focal distance, and characteristics of image focus.

24. A method according to claim 20, in which adjustments are made to levels of performance of the optical system, and/or of the sensor or generator, and/or of a synchronization system, or to average levels of performance, to the levels of performance of the digital image processing means.

25. A method according to claim 20 in which:
the digital image processing means incorporates a means of improving image quality by acting on at least one of the parameters of the group comprising: vignetting of the image sensor and/or generator, lack of clarity of the image sensor and/or generator, noise, moiré phenomenon, and/or contrast,
and/or at least one parameter of the image sensor and/or generator is determined or selected in the group comprising: quality of pixels, an area of the pixels, a number of pixels, matrix of microlenses, anti-aliasing filters, geometry of the pixels, disposition of the pixels,
and/or at least one parameter of the synchronization system is determined or chosen relative to at least one element of the group comprising: measurement of focus, measurement of exposure, measurement of white balance, focus settings, aperture settings, exposure settings, sensor gain settings.

26. A method according to claim 20, in which at least one parameter of the image sensor or generator is determined or chosen relative to dimensions of the sensor or generator, the digital image processing means incorporating means for reduction of noise that permit minimization of dimensions of the image sensor or generator.

27. A method according to claim 20, in which the device further includes a synchronization system, and at least one parameter of the optical system, or a position of image layout function of distance of focus and/or of focal point is determined or chosen, such that clarity of the images is homogenous in a field of image, the synchronization system taking into account the position of the image layout function of the distance of focus and/or of the focal point.

28. A method according to claim 20, in which the device further includes a synchronization system, and wherein at least one parameter of the synchronization system, or exposure parameters, are specified or selected by taking account of capacity of correction of algorithms of correction of noise and/or of contrast and/or of blur of movement forming a part of the digital image processing means.

29. A method according to claim 20, in which the digital image processing means incorporates means to act on lack of clarity of the optical system and/or of the image sensor and/or generator, these means permitting production of an image recording and/or reproduction device that does not include a system for focus synchronization.

30. A method according to claim 20, in which dimensions of the device are determined according to capacity of the digital image processing means.

31. A method according to claim 20, in which the digital image processing means are at least in part included in the image recording and/or reproduction device.

32. A method according to claim 29, in which the digital image processing means are at least in part separate from the image recording and/or reproduction device.

33. A method according to claim 20, in which the optical system is selected from among pre-existing optical systems.

34. A method according to claim 20, in which the sensor or generator is chosen from among pre-existing sensors or generators.

35. A method according to claim 20, further comprising:
defining an overall schedule of specifications of the device, and
establishing correlatively, or in an iterative manner, a schedule of specifications of the optical system and/or a schedule of specifications of the image sensor and/or generator and/or a schedule of specifications of the synchronization system, and a schedule of specifications of the digital image processing means according to an overall schedule of specifications,
such that one can transfer performances of the schedule of specifications of the optical system, and/or the schedule of specifications of the image sensor and/or generator and/or the schedule of specifications of the synchronization system, to the schedule of specifications of the digital image processing means, and/or such that the method allows reduction of production costs of the device.

36. A method according to claim 20, in which the digital image processing means incorporates a means of improving image quality by acting on at least one of parameters of the group comprising: vignetting of the optical system and/or of the image sensor and/or generator, lack of clarity of the optical system and/or of the image sensor and/or generator, noise, moire phenomenon, and/or contrast.

37. A method according to claim 20, in which at least one parameter of the optical system is determined or chosen from the group comprising: a number of optical elements of the system, nature of a material constituting the optical elements of the optical system, cost of materials of the optical system, treatment of optical surfaces, assembly tolerances, a value of parallax according to focal distance, characteristics of an aperture, a mechanism of the aperture, a range of possible focal lengths, characteristics of focusing, mechanisms of focusing, anti-aliasing filters, comprising, depth of field, characteristics linking the focal length and the focusing, geometric distortions, chromatic aberrations, decentering, vignetting, and characteristics of clarity.

38. An image recording and/or reproduction device obtained by the method of production according to claim 20.
